(19) United States
(12) Patent Application Publication
(10) Pub. No.: US 2005/0016530 A1
(43) Pub. Date: Jan. 27, 2005

(54) Treatment planning with implantable bronchial isolation devices

(76) Inventors: John McCutcheon, Menlo Park, CA (US); Randy Campbell, Redwood City, CA (US); Antony Fields, San Francisco, CA (US)

Correspondence Address: FISH & RICHARDSON, PC, 12390 EL CAMINO REAL, SAN DIEGO, CA, 92130-2081, US

(21) Appl. No.: 10/887,337

(22) Filed: Jul. 8, 2004

Related U.S. Application Data
(60) Provisional application No. 60/485,987, filed on Jul. 9, 2003.

(51) Int. Cl. A62B 7/00

(52) U.S. Cl. 128/200.24

(57) ABSTRACT

Disclosed is a treatment planning method that can be used to maximize the effectiveness of minimally invasive treatment on a patient. Pursuant to the treatment planning method, the presence of lung disease, such as emphysema, is first identified, followed by a determination of the distribution and extent of damage of the disease, followed by a determination of whether the patient is suitable for treatment, and a determination of the appropriate strategy for treatment for a suitable patient.

### REFERENCE TO PRIORITY DOCUMENT

This application claims priority of co-pending U.S. Provisional Patent Application Ser. No. 60/485,987, entitled “Treatment Planning With Implantable Bronchial Isolation Devices”, filed Jul. 9, 2003. Priority of the aforementioned filing date is hereby claimed, and the disclosure of the Provisional Patent Application is hereby incorporated by reference in its entirety.

### BACKGROUND

This disclosure relates generally to pulmonary procedures and, more particularly, to methods for planning treatment of lung disease using minimally invasive treatment methods.

Certain pulmonary diseases, such as emphysema, reduce the ability of one or both lungs to fully expel air during the exhalation phase of the breathing cycle. Such diseases are accompanied by chronic or recurrent obstruction to air flow within the lung. One of the effects of such diseases is that the diseased lung tissue is less elastic than healthy lung tissue, which is one factor that prevents full exhalation of air. During breathing, the diseased portion of the lung does not fully recoil due to the diseased (e.g., emphysematic) lung tissue being less elastic than healthy tissue. Consequently, the diseased lung tissue exerts a relatively low driving force, which results in the diseased lung expelling less air volume than a healthy lung.

The problem is further compounded by the diseased, less elastic tissue that surrounds the very narrow airways that lead to the alveoli, which are the air sacs where oxygen-carbon dioxide exchange occurs. The diseased tissue has less tone than healthy tissue and is typically unable to maintain the narrow airways open until the end of the exhalation cycle. This traps air in the lungs and exacerbates the already-inefficient breathing cycle. The trapped air causes the tissue to become hyper-expanded and no longer able to effect efficient oxygen-carbon dioxide exchange.

In addition, hyper-expanded, diseased lung tissue occupies more of the pleural space than healthy lung tissue. In most cases, a portion of the lung is diseased while the remaining part is relatively healthy and, therefore, still able to efficiently carry out oxygen exchange. By taking up more of the pleural space, the hyper-expanded lung tissue reduces the amount of space available to accommodate the healthy, functioning lung tissue. As a result, the hyper-expanded lung tissue causes inefficient breathing due to its own reduced functionality and because it adversely affects the functionality of adjacent healthy tissue.

Lung reduction surgery is one method of treating emphysema. Lung volume reduction surgery (LVRS) involves the surgical removal of hyperinflated portions of the lung destroyed by emphysema in order to allow the remaining, and presumably healthier, lung tissue to re-inflate and to allow the chest cavity and diaphragm to return to a more mechanically advantageous shape. However, such a conventional surgical approach is relatively traumatic and invasive, and, like most surgical procedures, is not a viable option for all patients.

Consequently, minimally invasive methods have been developed for treating diseases, such as emphysema, that reduce the ability of one or both lungs to fully expel air during the exhalation phase of the breathing cycle. Unlike LVRS, which requires surgically opening the chest cavity, minimally invasive treatments are performed by inserting devices such as catheters and bronchoscopes through the trachea and into the lung without surgically opening the chest cavity. The intent of LVRS is similar to these minimally invasive lung isolation methods in that the goal is the restoration of more normal lung function by isolating diseased lung tissue. A variety of minimally invasive methods are described below.

One important difference between LVRS and these minimally invasive methods is that with LVRS, the chest cavity is opened surgically. The lungs may be accessed and treated directly through a medial sternotomy or a thoracotomy, or endoscopically through a procedure known as VATS or video-assisted thoracic surgery. Whichever method is used, an incision is made in the chest, and the surgeon performing the procedure can directly view and/or feel the lungs to determine which portions of the lung are most damaged and thus are the portions that should be targeted and removed. By contrast, minimally invasive methods are performed without the chest being surgically opened, requiring the doctor performing the procedure to rely on methods other than external visualization or manual manipulation of the diseased lung to determine the most appropriate regions to isolate or treat. Additionally, the minimally invasive lung methods may provide clinical improvement via different mechanisms of action than LVRS, and these mechanisms of action may require different patient selection and treatment targeting methods than LVRS. These mechanisms of action may include absorption atelectasis, atelectasis via venting of exhaled air through implanted one-way valve bronchial isolation devices, reduction of dead-space ventilation, improved ventilation and perfusion matching, dampening of dynamic hyperinflation, reduction of residual volume (RV) by improving the net elastic recoil of the lung(s), as well as other, as yet unknown mechanisms.

Other diseases in addition to emphysema that are suitable for minimally invasive methods include chronic bronchitis, obliterative bronchiolitis and air leaks. It should be appreciated that this is not a complete list of diseases and conditions that are suitable for application of the diagnosis and treatment methods presented here.

In view of the foregoing, there is a need for methods of determining which patients are best suited for treatment with minimally invasive lung isolation, methods of determining the extent and location of the lung damage, and methods of determining the treatment plan for isolating or appropriately modifying the gas dynamics in the targeted portions of the lung. The methods are desirably adapted to minimally invasive approaches and do not require direct access or visualization of the lungs.

### SUMMARY

Disclosed is a method of determining a treatment strategy for minimally invasive lung treatment, comprising performing at least one diagnostic procedure on a patient to obtain at least one diagnostic result and determining that the patient is eligible for minimally invasive lung treatment if at least one diagnostic result satisfies predetermined eligibility criteria.

Also disclosed is a method of planning lung treatment, comprising detecting the presence, degree, and distribution of a disease in the lung; analyzing results of the detecting step to obtain at least one grade indicative of the level of disease in at least one region of the lung; and identifying a lung or a region of the lung to be treated based on at least one grade obtained in the analyzing step.

Also disclosed is a method of determining a treatment strategy for minimally invasive lung treatment of a patient, comprising performing at least one test on the patient to obtain data indicative of a lung disease and developing a treatment plan based on the data, wherein the treatment plan specifically identifies at least one lung region to be targeted for minimally-invasive lung treatment.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A shows an anterior view of a pair of human lungs and a bronchial tree with a bronchial isolation device implanted in a bronchial passageway to bronchially isolate a region of the lung.

FIG. 1B shows a perspective view of an exemplary bronchial isolation device.

FIG. 1C shows a cross-sectional, perspective view of the bronchial isolation device of FIG. 1B.

FIG. 2 illustrates an anterior view of a pair of human lungs and a bronchial tree.

FIG. 3 illustrates a lateral view of the right lung.

FIG. 4 illustrates a lateral view of the left lung.

FIG. 5 illustrates an anterior view of the trachea and a portion of the bronchial tree.

FIG. 6 shows a flow diagram that describes a planning method for minimally invasive treatment of lung disease.

FIG. 7 shows a flow diagram that describes a method of targeting a lung and lung region for minimally invasive treatment.

### DETAILED DESCRIPTION

Disclosed are methods for treatment planning for minimally invasive methods of treating pulmonary disease, such as emphysema. As used herein, the terms “minimally invasive methods” and “minimally invasive treatments” refer to lung disease treatment methods on a patient performed without the chest of the patient being surgically opened. Minimally invasive methods are performed by inserting devices such as catheters and bronchoscopes through the trachea and into the lung without surgically opening the chest cavity. Some exemplary minimally-invasive methods are described below. Pursuant to some of the minimally invasive methods, one or more regions of the lung are “isolated” such that fluid flow to and/or from the one or more regions is reduced or eliminated. In others, new channels are created in bronchial walls to create flow pathways to distal lung parenchyma.

As discussed, minimally invasive methods are performed without the chest being surgically opened, requiring the doctor performing the procedure to rely on methods other than manual manipulation of the diseased lung to determine the most appropriate lung regions to isolate or treat. Additionally, the minimally invasive lung methods for the treatment of emphysema can provide clinical improvement via different mechanisms of action than LVRS, and can require different patient selection and treatment targeting methods than LVRS.

Exemplary Minimally Invasive Methods

There are numerous minimally invasive methods for isolating or redirecting gas flow in a region or regions of the lung for treatment of pulmonary disease, such as emphysema or air leaks, intended to modify the gas flow dynamics during respiration for volume reduction, reduction of dynamic hyperinflation, collapse of the lung region(s), or to reduce or seal lung air leaks.

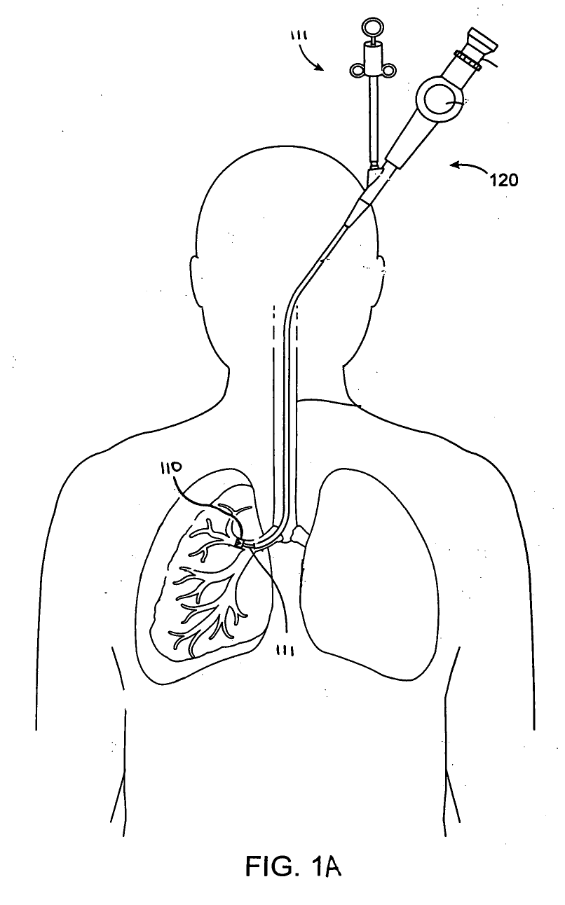

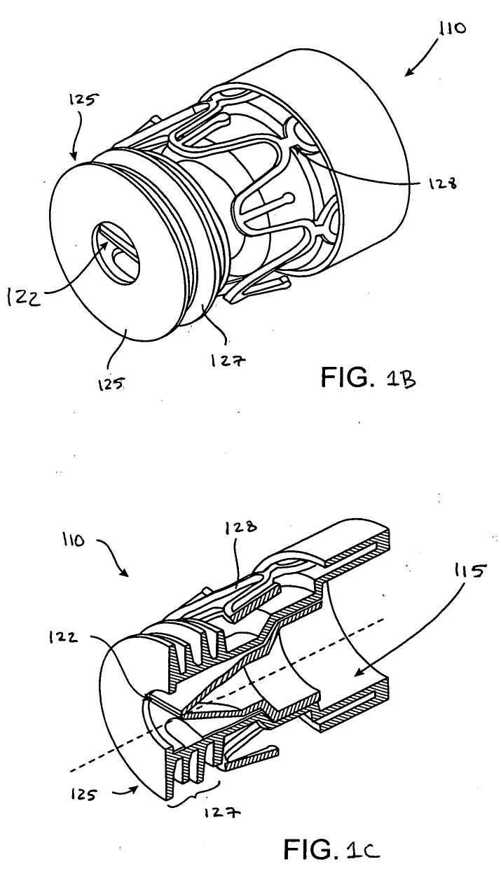

One such minimally invasive method involves the implantation in the lung(s) of one or more bronchial isolation devices. The bronchial isolation devices can be, for example, one-way valves that allow flow in the exhalation direction only, occluders or plugs that prevent flow in either direction, or two-way valves that control flow in both directions. As shown in FIG. 1A, a bronchial isolation device 110 is delivered to a target location in a bronchial passageway by mounting the device 110 at the distal end of a delivery catheter 111 and then inserting the delivery catheter into the bronchial passageway. Once the distal end is properly is positioned in the bronchial passageway, the bronchial isolation device 110 is ejected from the delivery catheter 111 and deployed within the passageway. In the example shown in FIG. 1, the distal end of the delivery catheter 111 is inserted into the patient's mouth or nose, through the trachea, and down to a target location in the bronchial passageway using a bronchoscope 120. Alternately, the delivery catheter 111 can be guided to the target location in the patient's lungs using a guidewire.

An exemplary bronchial isolation device 110 that permits one-way fluid flow therethrough is shown in FIGS. 1B and 1C. The bronchial isolation device 110 includes a main body that defines an interior lumen 115 (FIG. 1C) through which fluid can flow along a flow path. The flow of fluid through the interior lumen 115 is controlled by a valve member 122. The valve member 122 in FIGS. 1A and 1B is a one-way valve, although two-way valves can also be used, depending on the type of flow regulation desired.

The bronchial isolation device 110 has a general outer shape and contour that permits the bronchial isolation device 110 to fit entirely within a body passageway, such as within a bronchial passageway. The bronchial isolation device 110 includes an outer seal member 125 that provides a seal with the internal walls of a body passageway when the bronchial isolation device is implanted into the body passageway. The seal member 125 includes a series of radially-extending, circular flanges 127 that surround the outer circumference of the bronchial isolation device 110. The bronchial isolation device 110 also includes an anchor member 128 that functions to anchor the bronchial isolation device 2000 within a body passageway. It should be appreciated that device shown in FIGS. 1B and 1C is exemplary and that other types of bronchial isolation devices can be used to bronchially isolate the targeted lung region.

The following references describe exemplary bronchial isolation devices and corresponding delivery devices: U.S. Pat. No. 5,954,766 entitled “Body Fluid Flow Control Device”; U.S. patent application Ser. No. 09/797,910, entitled “Methods and Devices for Use in Performing Pulmonary Procedures”; U.S. patent application Ser. No. 10/270,792, entitled “Bronchial Flow Control Devices and Methods of Use”; U.S. patent application Ser. No. 10/448,154, entitled “Guidewire Delivery of Implantable Bronchial Isolation Devices in Accordance with Lung Treatment”; U.S. patent application Ser. No. 10/275,995, entitled “Bronchiopulmonary Occlusion Devices and Lung Volume Reduction Methods”; U.S. patent application Ser. No. 10/645,473, entitled “Delivery Methods and Devices for Implantable Bronchial Isolation Devices”; U.S. patent application Ser. No. 10/627,941, entitled “Bronchial Flow Control Devices with Membrane Seal”; and U.S. patent application Ser. No. 10/723,273, entitled “Delivery Methods and Devices for Implantable Bronchial Isolation Devices”. The foregoing references are all incorporated by reference in their entirety and are all assigned to Emphasys Medical, Inc., the assignee of the instant application.

Other types of minimally invasive methods also exist, including the infusion of glue or other therapeutic agents into the targeted lung region in order to seal or fibrose the lung tissue, the application of RF energy, the injection of bulking agents into the airway walls, and the application of internal and external ligating clips. These methods are intended to close or at least partially close the airways in order to isolate a region of the lung. Minimally invasive methods have also been proposed whereby the gas in the lung region targeted for isolation is evacuated either prior to or after sealing with one or more plugs or a one-way valves. As mentioned, all of these treatments are performed in a minimally invasive manner in that they are performed by inserting catheters and bronchoscopes through the trachea and into the lung without surgically opening the chest cavity.

Another minimally invasive lung treatment method does not isolate lung tissue, but creates new channels in the walls of bronchial lumens leading to lung regions targeted for treatment. These bronchial wall channels or collaterals are intended to improve the volume of air flowing from the treated lung regions during exhalation to mitigate the effects of increased airway resistance hyperinflation often seen with emphysema. Such methods are described in U.S. patent application Ser. No. 10/448,153 entitled “Modification Of Lung Region Flow Dynamics Using Flow Control Devices Implanted In Bronchial Wall Channels”, which is incorporated by reference in its entirety and assigned to Emphasys Medical, Inc., the assignee of the instant application.

It should be appreciated that the treatment planning methods described herein are not limited solely to use with the minimally invasive methods described above and that the treatment planning methods can be used in conjunction with other types of minimally invasive methods for treating lung disease.

Exemplary Lung Anatomy

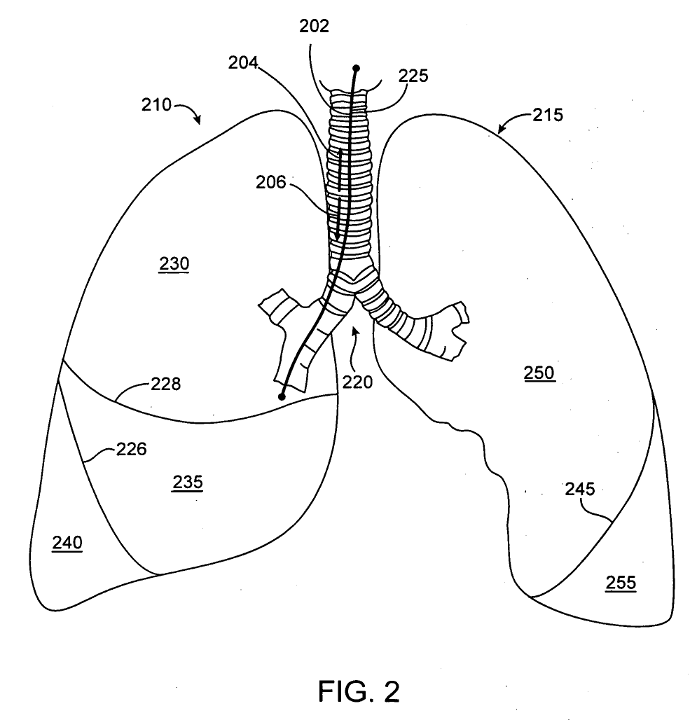

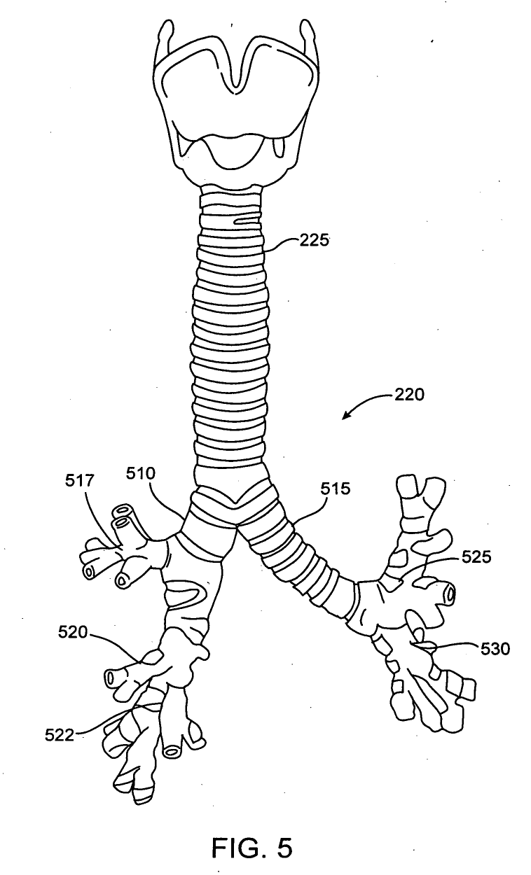

FIG. 2 shows an anterior view of a pair of human lungs 210, 215 and a bronchial tree 220 that provides a fluid pathway into and out of the lungs 210, 215 from a trachea 225, as will be known to those skilled in the art. As used herein, the term “fluid” can refer to a gas, a liquid, or a combination of gas(es) and liquid(s). For clarity of illustration, FIG. 2 shows only a portion of the bronchial tree 220, which is described in more detail below with reference to FIG. 5.

Throughout this description, certain terms are used that refer to relative directions or locations along a path defined from an entryway into the patient's body (e.g., the mouth or nose) to the patient's lungs. The path of airflow into the lungs generally begins at the patient's mouth or nose, travels through the trachea into one or more bronchial passageways, and terminates at some point in the patient's lungs. For example, FIG. 2 shows a path 202 that travels through the trachea 225 and through a bronchial passageway into a location in the right lung 210. The term “proximal direction” refers to the direction along such a path 202 that points toward the patient's mouth or nose and away from the patient's lungs. In other words, the proximal direction is generally the same as the expiration direction when the patient breathes. The arrow 204 in FIG. 2 points in the proximal or expiratory direction. The term “distal direction” refers to the direction along such a path 202 that points toward the patient's lung and away from the mouth or nose. The distal direction is generally the same as the inhalation or inspiratory direction when the patient breathes. The arrow 206 in FIG. 2 points in the distal or inhalation direction.

The lungs include a right lung 210 and a left lung 215. The right lung 210 includes lung regions comprised of three lobes, including a right upper lobe 230, a right middle lobe 235, and a right lower lobe 240. The lobes 230, 235, 240 are separated by two interlobar fissures, including a right oblique fissure 226 and a right transverse fissure 228. The right oblique fissure 226 separates the right lower lobe 240 from the right upper lobe 230 and from the right middle lobe 235. The right transverse fissure 228 separates the right upper lobe 230 from the right middle lobe 235.

As shown in FIG. 2, the left lung 215 includes lung regions comprised of two lobes, including the left upper lobe 250 and the left lower lobe 255. An interlobar fissure comprised of a left oblique fissure 245 of the left lung 215 separates the left upper lobe 250 from the left lower lobe 255. The lobes 230, 235, 240, 250, 255 are directly supplied air via respective lobar bronchi, as described in detail below.

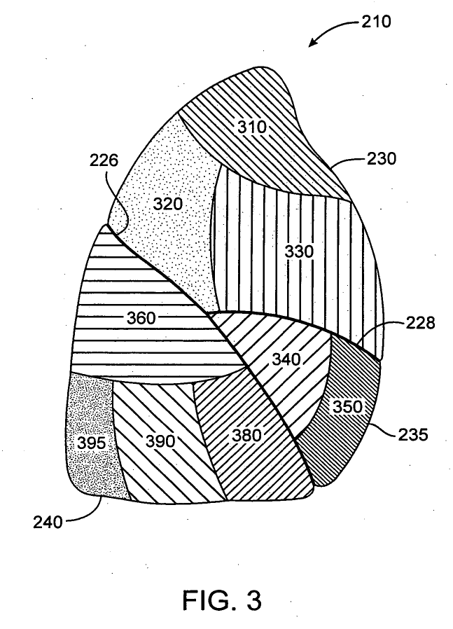

FIG. 3 is a lateral view of the right lung 210. The right lung 210 is subdivided into lung regions comprised of a plurality of bronchopulmonary segments. Each bronchopulmonary segment is directly supplied air by a corresponding segmental tertiary bronchus, as described below. The bronchopulmonary segments of the right lung 210 include a right apical segment 310, a right posterior segment 320, and a right anterior segment 330, all of which are disposed in the right upper lobe 230. The right lung bronchopulmonary segments further include a right lateral segment 340 and a right medial segment 350, which are disposed in the right middle lobe 235. The right lower lobe 240 includes bronchopulmonary segments comprised of a right superior segment 360, a right medial basal segment (which cannot be seen from the lateral view and is not shown in FIG. 3), a right anterior basal segment 380, a right lateral basal segment 390, and a right posterior basal segment 395.

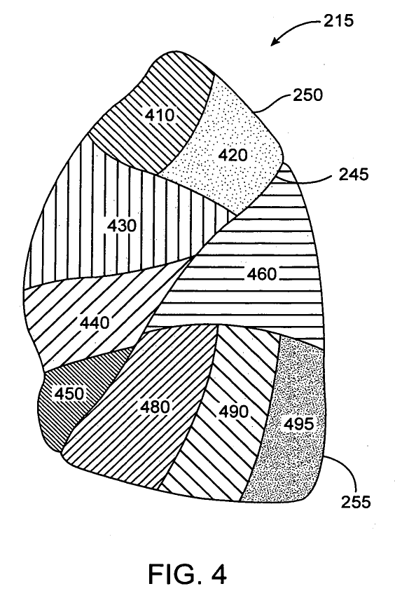

FIG. 4 shows a lateral view of the left lung 215, which is subdivided into lung regions comprised of a plurality of bronchopulmonary segments. The bronchopulmonary segments include a left apical segment 410, a left posterior segment 420, a left anterior segment 430, a left superior lingular segment 440, and a left inferior lingular segment 450, which are disposed in the left lung upper lobe 250. The lower lobe 255 of the left lung 215 includes bronchopulmonary segments comprised of a left superior segment 460, a left medial basal segment (which cannot be seen from the lateral view and is not shown in FIG. 4), a left anterior basal segment 480, a left lateral basal segment 490, and a left posterior basal segment 495.

FIG. 5 shows an anterior view of the trachea 325 and a portion of the bronchial tree 220, which includes a network of bronchial passageways, as described below. The trachea 225 divides at a lower end into two bronchial passageways comprised of primary bronchi, including a right primary bronchus 510 that provides direct air flow to the right lung 210, and a left primary bronchus 515 that provides direct air flow to the left lung 215. Each primary bronchus 510, 515 divides into a next generation of bronchial passageways comprised of a plurality of lobar bronchi. The right primary bronchus 510 divides into a right upper lobar bronchus 517, a right middle lobar bronchus 520, and a right lower lobar bronchus 422. The left primary bronchus 415 divides into a left upper lobar bronchus 525 and a left lower lobar bronchus 530. Each lobar bronchus 517, 520, 522, 525, 530 directly feeds fluid to a respective lung lobe, as indicated by the respective names of the lobar bronchi. The lobar bronchi each divide into yet another generation of bronchial passageways comprised of segmental bronchi, which provide air flow to the bronchopulmonary segments discussed above.

As is known to those skilled in the art, a bronchial passageway defines an internal lumen through which fluid can flow to and from a lung or lung region. The diameter of the internal lumen for a specific bronchial passageway can vary based on the bronchial passageway's location in the bronchial tree (such as whether the bronchial passageway is a lobar bronchus or a segmental bronchus) and can also vary from patient to patient. However, the internal diameter of a bronchial passageway is generally in the range of 3 millimeters (mm) to 10 mm, although the internal diameter of a bronchial passageway can be outside of this range. For example, a bronchial passageway can have an internal diameter of well below 1 mm at locations deep within the lung. The internal diameter can also vary from inhalation to exhalation as the diameter increases during inhalation as the lungs expand, and decreases during exhalation as the lungs contract.

Planning Methods for Minimally Invasive Treatment

Various exemplary minimally invasive treatment methods were described above. Disclosed is a treatment planning method that can be used to maximize the effectiveness of minimally invasive treatment on a patient. Pursuant to the treatment planning methodology, the presence of lung disease, such as emphysema, is first identified, followed by a determination of the distribution and extent of damage of the disease, followed by a determination of whether the patient is suitable for treatment, and finally a determination of the appropriate strategy for treatment for a suitable patient.

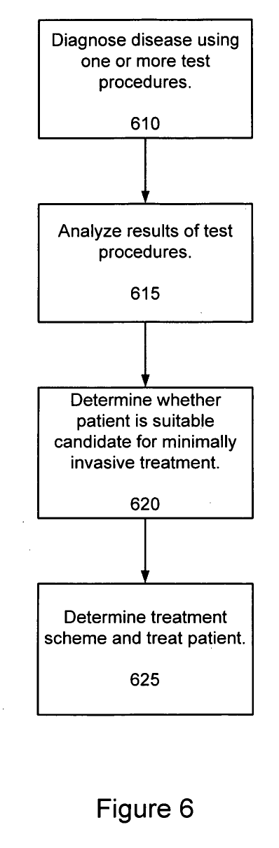

The treatment planning method is now described with reference to the flow diagram shown in FIG. 6. From a high-level standpoint, the treatment planning method generally includes four main steps. In an initial step, represented by the first flow diagram box 610 in FIG. 6, the disease is diagnosed, which comprises detecting the presence, distribution and degree of damage of the emphysema or other pulmonary disease using one or more test procedures in order to obtain results. Next, the results of the test procedures are analyzed, as represented by the flow diagram box 615. In the next step, represented by the flow diagram box 620, it is determined whether the patient is a suitable candidate for treatment. A scheme for targeting the regions of the lung for treatment is then determined, as represented by the flow diagram box 625 and the patient is treated using minimally invasive methods. All of the steps are described in more detail below.

1. Disease Diagnosis

As discussed, the first step of the treatment planning method is to use one or more test or diagnostic procedures on the patient to diagnose the lung disease. The diagnostic procedures yield one or more results, some or all of which are later used to determine whether a patient is eligible for minimally invasive treatment. Diagnosis of the lung disease includes determining the presence, distribution and degree of damage of the lung disease. The treatment planning method is described herein in the context of treating the disease comprising emphysema, which is defined pathologically as a permanent, abnormal air-space enlargement that occurs distal to the terminal bronchiole, and includes destruction of alveolar septa. (Albert R, Spiro S and Jett J, Comprehensive Respiratory Medicine. Harcourt Brace and Company Limited, 1999, pp 7.37.1.) It should be appreciated that the treatment planning methods can be used in conjunction with treating lung disease other than emphysema.

There are different techniques for diagnosing emphysema in a patient and various exemplary diagnostic techniques are described herein. In one embodiment, the diagnostic techniques comprise one or more pulmonary function tests, exercise tolerance tests, plethysmographic tests, blood analysis tests or other test that measure certain aspects of the entire pulmonary system of the patient. These tests and some of the corresponding results of the tests include, for example:

Spirometric Tests
FEV₁(forced expiratory volume in one second)
FVC (forced vital capacity)
FEF_{25%-75%} (forced expiratory flow, 25% to 75%)
VC (vital capacity)
IC (inspiratory capacity)
IRV (inspiratory reserve volume)

Diffusing capacity (DLco)

Plethysmographic Tests
RV (residual volume)
TLC (total lung capacity)
RV/TLC (residual volume divided by total lung capacity)
VC (vital capacity)
IC (inspiratory capacity)
IRV (inspiratory reserve volume)
FRC (functional residual capacity)
R_{aw}In (inspiratory airway resistance)
R_{aw}Ex (expiratory airway resistance)

Exercise Tolerance Tests
6MWT (six minute walk test)
6 Minute Shuttle Walk Test
Cycle Ergometry
Dynamic Volume Tests
Dynamic hyperinflation
Blood Analysis Tests
Blood gases
Blood oxygen saturation

Supplemental oxygen requirements

Body mass index (BMI)

Intralobar collateral flow

Interlobar collateral flow

As described below, the results of one or more tests can be used alone or in combination to determine whether a patient is eligible for minimally invasive treatment and can also be used to target a region or regions of the lung for treatment. Each of these tests listed above can be used alone or in combination to give information as to the condition and disease status of the pulmonary system. These tests provide aggregate information regarding the lung function of both lungs. Consequently, these tests do not provide any information as to the specific location or locations in the lung of the disease destruction. Emphysema can manifest itself in numerous ways, and the destruction of the lung parenchyma may be spread throughout the lung as in homogeneous disease, may be found to be predominantly in certain areas as with heterogeneous disease, or may be a combination of the two. With heterogeneous disease, the destruction may be located primarily in the apices of the upper lobes, it might be predominantly in the lower lobes, or in any other part of the lungs.

Given the uncertainty of the location of the emphysematous destruction, it can be desirable that a diagnostic technique be used that will accurately identify the areas of destruction and that will determine the degree of destruction in the areas where destruction is present. Some other regional or localized lung characteristics that may have important implications for these treatment methods include elastic recoil, preferential dynamic hyperinflation, and the existence and extent of collateral pathways that are either preexisting or are formed through the progressive destruction of emphysema. Some of these diagnostic techniques that provide regional or localized information about the disease state of the lungs are imaging techniques and they include, for example:
Chest x-rays
Computed tomography (CT) scans
High resolution computed tomography (HRCT) scans
Magnetic resonance imaging (MRI) scans
MRI scans with inhaled hyper-polarized gas
Ventilation/perfusion (V/Q) scans
Positron emission tomography (PET) scans
SPECT scans

Alternately, pulmonary function tests such as FEV₁ or RV that are performed on a portion of the lung, for example a lobe of a lung, rather than on the whole lung can give regional or localized information about the disease state and condition of the lungs that cannot be obtained with pulmonary function tests that are performed on the lungs as a whole.

In one specific embodiment, the diagnostic technique comprises a ventilation and perfusion (V/Q) scan, which is used to diagnose the disease (such as emphysema). The ventilation and perfusion (V/Q) scan is a diagnostic technique that is commonly used by thoracic surgeons and others for targeting LVRS resection, and is comprised of a ventilation scan and a perfusion scan.

The perfusion scan relies on the theory that where there is destruction in the lungs, the capillary bed has been destroyed by the disease. The perfusion scan is a nuclear imaging scan where a radioactive tracer dye is injected into the patient's bloodstream, and images of the chest are captured with a nuclear imaging camera once the tracer has had a chance to be fully circulated through the patient's bloodstream. Images of the chest are taken at many different angles in order to capture all characteristics of the blood flow in the lungs. The tracer dye shows up as dark regions on the camera image. Consequently, a perfusion scan images a healthy lung as an evenly dark lung-shaped area.

However, where blood flow is absent (such as where damage is present), the camera image is light or un-marked. Thus, lung areas with extensive emphysema damage (where the capillary bed is destroyed) will have little or no blood flow. Consequently, these areas show up as very light on the perfusion scan. This scan can be very helpful in seeing in general terms the location of the worst physiological disruption. One problem with relying on the perfusion scan to assess the location of emphysemic destruction is that often in patients with emphysema the healthy lung is compressed and has less blood flow to the area. This may lead to an erroneous interpretation of where the disease is greatest.

In a ventilation scan, the patient inhales a radioactive tracer gas such as xenon-133 or krypton-81m. Images of the patient's thorax are taken, typically in the posterior view, with a nuclear imaging camera during three phases: inhalation of the first breath as the tracer gas is inhaled, during equilibration as the lungs are completely filled with the tracer gas, and during the “washout” phase after the patient has stopped inhaling the tracer gas and is expelling it from his or her lungs. The gas shows up as dark or black on the ventilation scan image, and these dark regions indicate areas of preserved or active ventilation, and areas where no ventilation occur will show up on the image as white or unmarked. The ventilation scan can thus be helpful in identifying areas of poor ventilation for the purposes of targeting minimally invasive lung isolation.

In another embodiment, the diagnostic technique comprises a computed tomography (CT) or a variation thereof. The CT scan provides images of the chest based on the density of the tissue being scanned. Given that bronchial lumens, healthy lung parenchyma, open air spaces, vessels, etc. have differing tissue density, the CT scans of such tissue are differentiated from each other in the scan. In one embodiment, the CT scan is performed with the patient's chest at rest, and with the patient holding a fully inspired breath. The scans can also be taken with the patient's breath fully expired.

A variation of the conventional CT scan is the high resolution computed tomography scan (HRCT). The HRCT scan differs from the conventional CT scan in that it uses a very narrow x-ray beam collimation (1-1.3 mm slice thickness compared to conventional 8-10 mm) and a so-called ‘high spatial frequency reconstruction algorithm, to provide extremely high definition images of the lung parenchyma, including the pulmonary vessels, airspaces, airway and interstitium. The CT or HRCT scan take high definition images of the patient's chest at various levels throughout the chest cavity, which results in a set of cross-sectional images or slices of the patient's chest cavity from the top of the lungs to the bottom. A conventional CT scan produces results comprised of images that represent cross-sectional slices of the imaged tissue. The images can be a minimum of about 8 mm in thickness, which means that the image is an average of all of the tissue within the 8 mm slice thickness. Slices can be taken more closely together than the slice thickness, but this would result in tissue appearing in more than one slice, which can be undesirable. HRCT allows these images to be taken 1 mm apart or closer, and this has the result that the scan can capture smaller emphysematous lesions, and greater detail of the lung is possible. The images resulting from the CT or HRCT scan are digital in nature.

The images resulting from the scans (CT or HRCT) are examined to permit one to determine the location of regions of destruction, along with the relative degree of destruction, with great accuracy. In this regard, the images are used to determine the image density of various portions of the chest, which can provide an indication as to the amount of a healthy lung tissue and damaged lung tissue in a scanned area. This is because healthy lung tissue has a particular density, as does bone, fat, muscle, bronchial lumens, and open spaces such as areas of emphysematous destruction. Given knowledge of the varying density of these tissues, the images are analyzed to determine what percentage of a particular area is comprised of healthy lung tissue and what percentage is comprised of open areas of emphysematous destruction. As described below, the analysis of the images can be performed manually in that a person visually reviews the images. Alternately, or in combination with the manual analysis, the image analysis can be performed by a computer.

Analysis of the transitional areas from one level of destruction to another may enable inference of the degree of collateral airflow in that area. For example, two adjacent lobes may have extreme heterogeneity (e.g. the upper lobe >75% destroyed and the lower lobe <25% destroyed), and this might lead to the conclusion that collateral flow between the lobes is unlikely. However, it is possible that the majority of the emphysematous destruction in the lower lobe (less than 25% destroyed) is located in the lung parenchyma that is adjacent to the interlobar fissure between the lower and upper lobes. This localized destruction at the site of the interlobar fissure may create channels for collateral flow between the lower and upper lobes.

In one embodiment, a multi-detector CT scanner is deployed during diagnosis. A multi-detector CT scanner machine has a plurality of detectors, such as, for example, on the order of as many as 16 or more detectors that can capture images simultaneously. A use for this technology is that it allows a full set of chest images to be acquired in 7 seconds or less, and does not require multiple breath-hold maneuvers as some older, slower scanners require.

A diagnostic technique involving the use of a multi-detector CT scanner to perform a dynamic CT scan in combination with minimally invasive treatment is now described. The multi-detector CT scanners can be used to repeatedly capture an image of the same specific level in the lungs during the time it takes for the patient to perform a breathing maneuver (such as inspiration or expiration). This technique allows dynamic images of the lungs to be captured, and also permits regional differences in ventilation to be detected. This is done by analyzing the differences between rates of density change between various portions of the lung while the patient inhales or exhales. It has been observed that a region where the density changes rapidly is ventilating more effectively than an area where the density does not change very rapidly during inhalation or exhalation. These areas where density changes more rapidly may have a higher elastic recoil (lower compliance) indicating areas that should be preserved and not treated with minimally invasive lung isolation. Furthermore, areas where density changes slowly or not at all during breathing may have lower elastic recoil (higher compliance) indicating areas that should be isolated in any therapy that intends to isolate the portions of the lung with the worst (lowest) elastic recoil.

Analysis of the CT scan can be performed to determine which bronchial passageways feed these areas of low elastic recoil or poor ventilation, and minimally invasive lung isolation techniques can be performed in these passageways. Having this detailed information about local elastic recoil and ventilation available at the level of treatment targeting (i.e.: lung lobe, lung segment, lung sub-segment, etc., described below), allows isolation of the areas of the lung with the lowest elastic recoil or poorest ventilation, resulting in net functional improvement in lung function.

There are other scanning technologies available such as PET scans, MRI scans with inhaled hyper-polarized gas, SPECT scans, etc. It is contemplated that these and other emerging technologies can be used as the diagnostic technique in the treatment planning method. It should be appreciated that any of the aforementioned diagnostic techniques can be used alone or in combination to determine the presence, degree and distribution of emphysema or other pulmonary disease.

2. Data/Results Analysis

As discussed above, the diagnostic step yields results that can be analyzed. With reference again to FIG. 6, the next step (represented by the flow diagram box 615) is to analyze the results of the diagnostic step. Specifically, the results are analyzed to obtain information that can be used later in the method to determine whether the patient is a proper candidate for minimally invasive lung treatment and, if so, where the isolation should be performed for optimal treatment

As described below, in one embodiment the analysis yields one or more scores that provide an indication of the level of lung disease in one or more regions of the lung. The scores can be with respect to various regions of the lung thereby enabling one to identify which, if any, region(s) should be treated using minimally invasive methods. Minimally invasive methods can be performed to isolate various regions of the lung. For example, the minimally invasive method (such as the implantation of a bronchial isolation device) may be performed either in a lobar bronchus, which would result in the isolation of an entire lobe of the lung, or in the segmental or sub-segmental bronchi which would result in the isolation of a portion of a lung lobe. It is likely that bronchial isolation to treat emphysema is more effective in some patients than in others, and one of the governing factors in determining which patients to treat is the distribution of destruction throughout the lung, and the degree of destruction.

The results of the disease detection method used are analyzed to determine the distribution and degree of destruction in the lung. The results analysis is performed at whatever anatomical resolution is best suited for the bronchial isolation technique being used (i.e. on a lobe-by-lobe basis, a segment-by segment basis, etc.). Thus, the analysis can be performed with respect to any defined lung region. Moreover, the lung region can correspond to a conventionally-recognized lung region, such as a lung segment or lobe, or the lung region can be arbitrarily-defined. For example, the lung regions can correspond to each lung, or to each lobe of each lung. The lung regions can be defined with respect to any subset of the lung, such as by dividing the lung into zones or regions such as core and rind, or into upper, middle and lower zones. The analysis can also be performed on each segment of each lobe, or at each sub-segment of each segment of each lobe.

As mentioned, the results of the diagnostic step are analyzed to arrive at a grade indicative of the level of disease in a lung region. The method for arriving at the grade can vary. When CT and/or HRCT scans are used to detect the destruction due to the lung disease (such as emphysema), there is a method for grading the results, as described in Goddard PR, Nicholson EM, Laszlo G, Watt I., Computed Tomography in Pulmonary Emphysema. Clin Radiol 1982; 33:379-387 and Bergin C, Müller NL, Nichols DM, et al., The diagnosis of emphysema: a computed tomographic-pathologic correlation. Am Rev Respir Dis. 1986; 133:541-546, which are incorporated herein by reference in their entirety. Pursuant to this grading method, all CT or HRCT images (or slices) containing lung parenchyma are assessed, and the right and left lungs are graded separately according to the percentage area that demonstrates changes (low attenuation, lung destruction, and vascular disruption) suggestive of emphysema. The extent of emphysema is then graded on a scale from 0 to 4, with a grade of 0 indicating no emphysema and a grade of 4 indicating the presence of emphysema in more than 75 percent of the lung zone. Table 1 shows a range of exemplary grades comprised of Emphysema Scores and their corresponding indications.

TABLE 1
Emphysema Scores (ES)

| % of | |
|---|---|
| Parenchyma with | |
| Abnormalities | |
| Suggestive of | Emphysema |
| Emphysema | Score (ES) |
| 0 | 0 |
| 1-25% | 1 |
| 26-50% | 2 |
| 51-75% | 3 |
| >75% | 4 |

These scales were conceived of to help compensate for the imprecision of a radiologist's visual assessment of emphysema destruction. For example, a scale of 0-100% using degree of destruction is too fine of a scale for a visual read that may only be accurate to within 10%. A scale of 0-4 is sufficiently gross to account for the precision of the visual read. As more quantitative methods become commonly available, it is envisioned that these scales may be revised to reflect the greater sensitivity and precision of quantitative HRCT analysis.

In one embodiment, an individual such as a radiologist visually assesses the score by reading the CT scan and qualitatively assigning an emphysema score to each slice in the image set. However, such a score assessment is subject to the bias of the radiologist reading the scan, and can result in a substantial amount of variation from analysis to analysis, and from reader to reader as described in Bankier M, Maertelaer VD, Keyzer C, Gevenois PA. Pulmonary Emphysema: Subjective Visual Grading versus Objective Quantification with Macroscopic Morphometry and Thin-Section CT Densitometry, Radiology 1999;211:851-858.

In an alternative embodiment, a quantitative analysis of the emphysema destruction is performed by using a computer that analyzes the density variations within each image slice. The computer is provided with data indicative of known ranges for the density of lung parenchyma, for open air spaces, for fat, muscle, etc. Given these densities, the computer is configured to automatically remove from the image any tissue surrounding the lung that is not part of the lung. Thus, all that all that remains is the image of the lung. Following this, the lung image may then analyzed by the computer to determine the percentage of healthy lung parenchyma, and the percentage of open or destroyed area.

In order to assign scores to the lung regions, the lung regions are first defined. In one embodiment, each lung is divided into zones based on the number of slices taken on the CT or HRCT scan. For example, each lung can be divided into three zones (Upper=U, Middle=M, Lower=L). If there are a total of 30 slices, for example, from the apex of the lungs to the diaphragm, the zones are split into three equal areas of 10 slices each. It should be appreciated that the number of slices in each zone can vary and can differ from one another. For example, if the number of slices is not divisible by three, the extra slice is put in the upper zone and then middle zone if there is another remainder. Each zone is then scored based on the estimated average Emphysema Score for that zone (either qualitatively by the radiologist, or quantitatively by a computerized method). In this example, the zones do not directly correspond to anatomical units of the lung (i.e.: lobes or segments). An example collection of scores for upper, middle, and lower zones is shown in Table 2.

TABLE 2
Example Zonal Emphysema Score (ES)

| | Right | Left |
|---|---|---|
| Upper Zone | 4 | 4 |
| Middle Zone | 2 | 1 |
| Lower Zone | 1 | 1 |

An alternative method for analyzing the results of the diagnostic step, and one that is particularly well suited for use in treatment with minimally invasive lung isolation, is to analyze the emphysema destruction on a lobar basis, rather than the zonal basis presented above. Pursuant to a lobar analysis, the images are divided into groups corresponding to the lung lobes. Given that the interlobar fissures are at an angle relative to the plane of the image slice, many slices will contain tissue from more than one lobe of the lung. The interlobar fissure dividing the lobes of the lung is readily visible on the CT image to a radiologist reading the scan if the slices are sufficiently thin, and thus a visual qualitative analysis on a lobar basis can be performed. In order to perform a quantitative lobar analysis with a computerized method, the computer is provided with information regarding the location of the interlobar fissure on each slice being analyzed.

This can be done one of various ways. In one embodiment, a human operator manually trace the interlobar fissure line digitally on the computer image using well-known devices, for example a pointing device such as a mouse or pen and tablet. Once provided with information regarding the interlobar fissure, the computer analyzes each lobe for emphysema damage. This method is very labor intensive. In order to reduce this work load and improve accuracy, a computer can be programmed to automatically segment the lung into lung tissue and into lobes. An example score for lobar analysis, rather than zonal analysis, is shown in Table 3.

TABLE 3
Example of Lobar Emphysema Score (ES)

| | Right | Left |
|---|---|---|
| Upper Lobe | 4 | 4 |
| Middle Lobe | 2 | N/a |
| Lower Lobe | 1 | 1 |

As mentioned previously, this destruction scoring may be performed at other subdivisions such as at the segmental level, at the sub-segmental level or at any other appropriate subdivision of the lungs. In addition, this analysis may be done with imaging based detection methods other that CT or HRCT such as SPECT scanning, hyper-polarized gas MRI scanning, etc.

Alternately, analysis can be performed on the results of other tests or diagnostic procedures such as various pulmonary function tests like FEV₁, RV, etc., that measure a parameter of the function of the lungs, or other system of the body, as a whole. A single parameter may be used, such as baseline FEV1, or a combination of measures may be used such as residual volume (RV) and forced vital capacity (FVC). These tests give results in the form of parameters that give information about the function of the pulmonary system as a whole. Limits may be set on these parameters to determine if they are above or below or equal to these limits. As discussed in the next section, a patient may be determined to be eligible for minimally invasive lung isolation based on whether or not certain of these parameters fall within predetermined limits.

3. Patient Selection

With reference again to FIG. 6, the third step of the treatment planning method (represented by the flow diagram box 620) is to determine if the patient is suitable (i.e., eligible) for minimally invasive methods based on the results obtained in the previous step. For example, the scoring results of the previous step are analyzed to determine if the patient is a proper candidate for minimally invasive lung treatment in order to isolate a lung region. As mentioned, in the case of the disease being emphysema, patients having the disease can have varying distribution and severity of damage. Consequently, not all patients are suitable for lung isolation. In another approach, the results of the diagnostic tests are compared to eligibility criteria to determine whether a patient is eligible for minimally invasive treatment, such as treatment with bronchial isolation devices. For example, the patient can be considered eligible for treatment if any of the diagnostic results (e.g., FEV₁, FVC, FEF_{25%-75%}) or a combination of the diagnostic results are within a predetermined value range.

Furthermore, if it is determined that a patient is suitable for minimally invasive methods, the resultant optimal treatment plan may differ based on various patient characteristics, including, for example, the emphysema distribution and the severity in the patient. Thus, the criteria for determining whether a patient is suitable for minimally invasive methods can comprise the location and degree of emphysema destruction in the lungs. This can also determine the particular treatment plan, such as which regions of the lung and which lung are targeted for treatment. It should be appreciated that the criteria for determining whether a patient is eligible for treatment can differ from the criteria for determining the treatment plan. The patient characteristics that can determine the treatment plan and whether the patient is suitable for treatment include the all of the tests and diagnostic procedures presented earlier.

In one embodiment, a patient is suitable patient for minimally invasive treatment when the patient has lung destruction predominantly in one lobe or region of a lung (left or right), and the remaining regions or lobes of that lung are generally less destroyed. The reason for this is that if the more heavily destroyed portions of the lung are isolated with the procedure, the remaining non-isolated portions of the lung are allowed to function more effectively by either being allowed to expand to a larger size due to the reduction in size of the isolated portions of the lung, or by having inhaled air flow more preferentially to these non-isolation portions of the lung. In either case, the patient's lung function is improved. Thus, a patient with a more heterogeneous distribution of disease, as opposed to a homogeneous or more evenly distributed disease, is considered highly suitable for minimally invasive methods of treatment.

There are now described two examples of patient selection methods that have been shown to result in improvements in lung function in the selected patients with emphysema after minimally invasive lung isolation. The first method is based on a zonal analysis of the previously-obtained data (such as the CT or HRCT data), and the second is based on a lobar analysis of the previously-obtained data.

In both examples in order to be radiologically eligible for treatment, the patient must have at least one lung that satisfies minimum criteria for heterogeneity and constraints regarding degree of parenchymal destruction within the lung. The previously-determined scores (e.g., the Emphysema Scores) are analyzed to determine whether the level of heterogeneity in each of the patient's lungs is sufficient for the patient to be suitable for treatment. In one embodiment, the patient is suitable for minimally invasive treatment if the disease is heterogeneous in at least one of the lungs. Heterogeneity can be determined using the previously-obtained scores. For example, if there is a difference in Emphysema Score (discussed above) between the Upper and Lower Lobes within a lung, the disease is considered heterogeneous and the patient is eligible for treatment. A patient with hybrid disease (i.e., one lung has heterogeneous disease and the other lung has homogeneous disease) may also be considered eligible for treatment as long as the lung with heterogeneous disease qualifies for treatment and the lung with homogeneous disease is not rated with maximal destruction as measured by Emphysema Score.

Two examples of patient selection methods are now described.

Patient Selection Example #1: Heterogeneous Disease with Zonal Analysis

The process for determining whether a patient is a suitable candidate for minimally invasive treatment is now described in the context of zonal analysis. According to the zonal analysis process, a patient is considered ineligible for minimally invasive treatment (i.e., the patient is excluded from treatment) if the distribution of the disease in the patient's lungs do not meet certain criteria. As mentioned, the Emphysema Scores are used to determine the distribution of the disease.

In one embodiment, a patient with Emphysema Score (ES) in either lung where Upper Zone=4, Middle Zone=4 and Lower Zone=4 is excluded from treatment. Table 4 includes a pair of charts that visually illustrate whether a patient satisfies the selection criteria relative to the patient's Emphysema Scores. The left-most column of each chart lists the possible Emphysema Scores for the right lung upper zone and the top-most of each chart row lists the possible Emphysema Scores for the right lung lower zone. A patient is considered eligible for minimally invasive treatment where the selection criteria are satisfied.

With reference to Table 4, all possible eligible Emphysema Score combinations for the upper and lower zone for a given patient are shown as unshaded boxes. In order to be radiologically eligible for treatment, the patient must have either left lung scores such that an un-shaded box of Table 4 applies to the patient and/or right lung scores such that an un-shaded box of Table 4 applies to the patient. That is, the patient is eligible for minimally invasive treatment where the Emphysema Score for the upper and lower zones differ from one another and where neither of the Emphysema Scores are “3” or “4” in one of the patient's lungs. This condition ensures sufficient heterogeneity within potential target lungs and sufficiently healthy tissue in zones adjacent to potential target zones. The target lungs and target zones are those lungs and zones that are targeted for minimally invasive treatment.

TABLE 4
Eligible Emphysema Score Combinations for Upper and Lower Zones

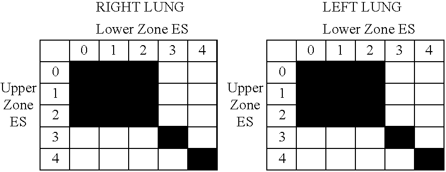

Patient Selection Example #2: Heterogeneous Disease with Lobar Analysis

The eligibility process is now described in the context of lobar analysis. According to the lobar analysis eligibility process, a patient is considered ineligible for minimally invasive treatment (i.e., the patient is excluded from treatment) if the distribution of the scores throughout the lung lobes do not meet certain criteria, wherein the criteria is based upon the scores obtained in the previous step. The lobar analysis eligibility process is similar to the zonal analysis process. However, the process differs because the left lung has no Middle Lobe.

Pursuant to the lobar analysis, in one embodiment a patient is excluded from treatment if all lobes of either lung have Emphysema Scores of 4. Table 5 shows a pair of charts that visually illustrates whether a patient satisfies the selection criteria relative to the patient's Emphysema Scores. With reference to Table 5, all possible eligible Emphysema Score combinations for the upper and lower lobe for a given patient are shown as unshaded boxes. In order to be radiologically eligible for treatment the patient must have either left lung scores such that an un-shaded box of Table 5 applies to the patient and/or right lung scores such that an un-shaded box of Table 5 applies to the patient. That is, the patient is eligible (i.e., is a suitable candidate) for minimally invasive treatment where the Emphysema Score for the upper and lower lobes differ from one another and where neither of the Emphysema Scores are “3” or “4” in one of the patient's lungs. As mentioned, this condition ensures sufficient heterogeneity within potential target lungs and sufficiently healthy tissue in lobes adjacent to potential target lobes.

TABLE 5
Eligible Emphysema Score Combinations for Upper and Lower Lobes

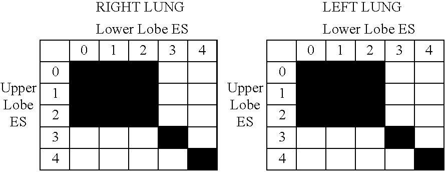

Other Patient Selection Criteria

As mentioned above, the foregoing two examples use HRCT scan analysis to determine patient eligibility for minimally invasive treatment. There are many other test methods that can be used as criteria for patient selection including other imaging tests such as MRI, chest x-ray, etc, as well as pulmonary function tests such as FEV₁, FVC, RV etc. These tests would be performed prior to treatment or at what is known as “baseline”. Tests that produce a quantified numerical result such as FEV₁, etc. can be compared to a calculated “predicted value”. The predicted value is usually calculated using the patients age, race, height and gender, and represents an average result for a similar healthy patient. The patient's test results are then calculated as a percentage of the predicted value, and this percentage demonstrates whether the patient is above or below the predicted value for a similar healthy patient. Patients may be selected for minimally invasive treatment based on a single test result, or on the combination of a number of different test results. In one embodiment, the eligibility criteria of Table 5 is used in combination with FEV₁, FVC and RV data to determine whether a patient is suitable for minimally invasive methods.

In another method, a patient is determined to be suitable for minimally invasive treatment if the patient meets three of three different test criteria when measured at baseline (prior to treatment). One example of three criteria would be a baseline FEV₁ less than 35% of the predicted value, a baseline FVC less than 70% of predicted and a RV greater than 175% of predicted or RV/TLC greater than 70% of predicted.

In yet another method, a patient is determined to be suitable for minimally invasive treatment if the patient meets two of three different test criteria when measured at baseline (prior to treatment). One example of a patient meeting two of three criteria would be a baseline FEV₁ greater than or equal to 35% of predicted (i.e. not meeting the criteria of being below 35% of predicted), with a baseline FVC less than 70% of predicted and a RV greater than 225% of predicted or RV/TLC greater than 75% of predicted.

In yet another method, a patient is determined to be suitable for minimally invasive treatment if the patient's inspiratory reserve volume (IRV) drops below a predetermined level or to zero when the patient is exercising on a cycle ergometer.

In yet another method, a patient is determined to be suitable for minimally invasive treatment by analysis of their inspiratory resistance (R_{aw}In). It can be desirable for the patient's R_{aw}In to be closer to normal than on the higher side (greater inspiratory resistance means that there is more airway disease). The theory is that if the patient has certain other limitations and near-normal inspiratory resistance, the limitations are due to loss of elastic recoil. If the greatest limitation is due to inspiratory resistance, then the benefit of minimally invasive methods (such as implantation of a bronchial isolation device) would be minimal. It has been shown in literature that the average R_{aw}In for a group of patients with emphysema was 9.5+/−4.2 cm water/liter/sec. In one embodiment, a patient is deemed suitable for minimally invasive treatment where the patient has low inspiratory resistance, demonstrates hyperinflation (e.g., RV>175%), and has breathing impairment (e.g., FEV1 <35%, FVC<70%). The patient can have low inspiratory resistance, for example, where the patient's Rawln is less than 10 cm water/liter/sec, less than 9 cm water/liter/sec, less than 8 cm water/liter/sec, less than 7 cm water/liter/sec, less than 6 cm water/liter/sec, or less than 5 cm water/liter/sec.

In yet another method, a patient is determined to be suitable for minimally invasive treatment by analysis of their forced vital capacity (FVC). In a patient with heterogeneous emphysema, the lower the patient's FVC, the greater is the improvement after minimally invasive lung isolation as measured by reduced RV and increased FEV₁ and 6MWT. One suitable cutoff level is the patient must have an FVC that is less than or equal to 80% of predicted. Another suitable cutoff is FVC≦70%. Yet another suitable cutoff is FVC≦60%. Yet another suitable cutoff is FVC≦50%. Yet another cutoff is FVC≦40%.

In yet another method, a patient is determined to be suitable for minimally invasive treatment if the patient reports exercise limitation due to breathlessness alone as opposed to exercise limitation due to leg fatigue or a mixture of leg fatigue and breathlessness.

4. Treatment Targeting

With reference again to FIG. 6, once it is determined that a patient is suitable for treatment with minimally invasive methods, a treatment targeting method is selected, as represented by the flow diagram box 625. The treatment targeting methods are used to identify at least one lung and at least one corresponding region of a lung that is a target for minimally invasive methods of treatment. As with patient selection, the results of the analysis of emphysema destruction are used to determine the optimal treatment plan for the particular patient that was determined to be eligible for treatment.

There are now described two examples of treatment targeting methods that have been shown to result in improvements in lung function after minimally invasive lung treatment in patients with heterogeneous disease distribution. Both of these examples represent a unilateral treatment method in which only one lobe of one lung is isolated using minimally invasive methods. It should be appreciated, however, that other treatment methods could be used such as multi-lobe and bilateral treatment methods, as well as segmental or other sub-lobar treatment methods.

In one embodiment, the treatment method is based on a zonal analysis of the previously-obtained data, such as the CT or HRCT data. In another embodiment, the treatment method is based on a lobar analysis of the data, such as the CT or HRCT data. As discussed above, the minimally invasive treatment can be achieved, for example, by implanting one or more bronchial isolation devices shown in FIG. 1A. However, other isolation methods can be used, such as the injection of glue or other therapeutic fluid, the implantation of occluders, plugs or blocker, application of staples or clips, and other methods, as described above and in the above-referenced patent applications.

Treatment Targeting Example #1: Heterogeneous Disease with Zonal Analysis

In the following embodiment the treatment targeting is based on zonal analysis using the previously-obtained scores, such as, for example, the CT or HRCT Emphysema Scores. As discussed above, the scores provide information regarding the degree of heterogeneity of the disease distribution as well as the severity of destruction caused by the disease. Two new measures of these disease attributes are now defined which enable relative and objective characterization of each patient's condition: the Heterogeneity Score (HS) and the Destruction Score (DS). Together with the Emphysema Scores, the Heterogeneity Score and the Destruction Score enable determination of the appropriate treatment targeting plan for each patient. The formulas for calculating the Heterogeneity Score (HS) and the Destruction Score (DS) are presented below in Table 6.

TABLE 6
Zonal Heterogeneity Score and Destruction Score

| | Right Lung | Left Lung |
|---|---|---|
| HRCT Grading | Upper Zone | Upper Zone |
| | Emphysema Score = a | Emphysema Score = c |
| | Lower Zone | Lower Zone |
| | Emphysema Score = b | Emphysema Score = d |
| Heterogeneity Score | \|a − b\| = Right HS | \|c − d\| = Left HS |
| (HS) | | |
| Destruction | a + b = Right DS | c + d = Left DS |
| Score (DS) | | |

Pursuant to the treatment plan, only one lobe of one lung is treated using minimally invasive methods. The first operation of the treatment targeting method is to determine which lung to treat with minimally invasive methods. As described below, the Emphysema Scores, Heterogeneity Scores, and Destruction Scores are successively used as criteria for determining which lung is to be treated. After the lung for treatment is determined, the operation is to determine which lobe of the lung to treat. The Emphysema Score is used to determine which lung lobe to treat.

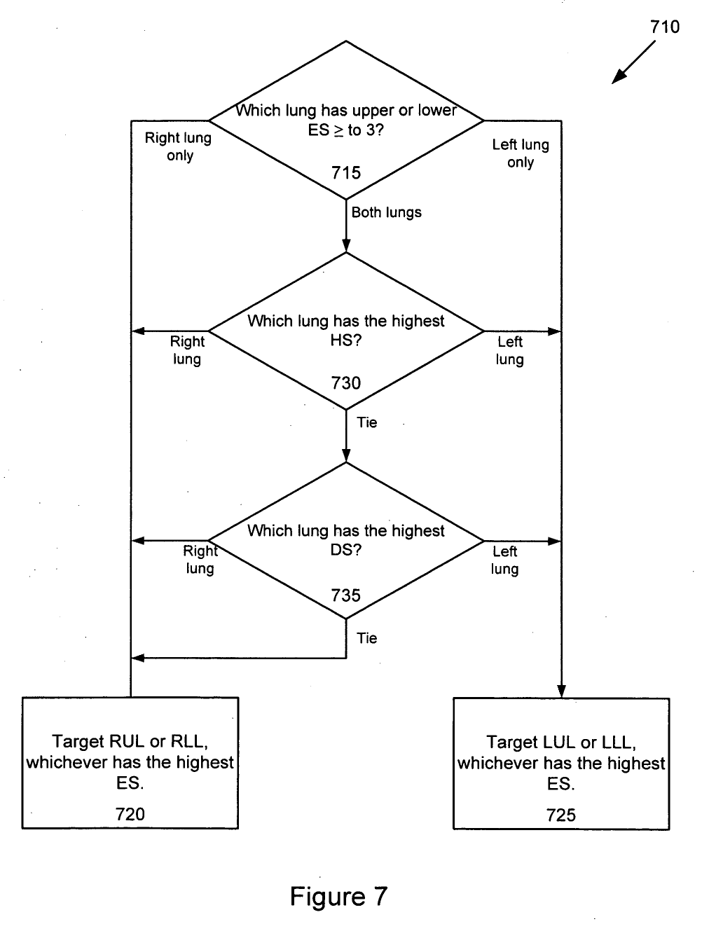

A flowchart 710 describing the process of determining which lung and which lobe to treat is shown in FIG. 7. With reference to FIG. 7, the treatment targeting method begins by determining which lung is to be treated with minimally invasive methods. In a first operation, it is determined which lung has an upper or lower Emphysema Score that is greater than or equal to 3, as represented by the decision box 715 in FIG. 7. In other words, it is determined which lung (i.e., right or left) has Emphysema Scores (ES) that correspond to an unshaded box in Table 4. If only the right lung has an upper or lower Emphysema Score that is greater than or equal to 3, then the process proceeds to the flow diagram box 720, where the right upper lobe (RUL) or right lower lobe (RLL) is targeted, whichever has the higher Emphysema Score. If it is determined that only the left lung has an upper or lower Emphysema Score that is greater than or equal to 3, then the process proceeds to the flow diagram box 725, where the left upper lobe (LUL) or left lower lobe (LLL) is targeted, whichever has the higher Emphysema Score. When a lobe is targeted, all of the bronchi leading in to the targeted lobe are isolated using minimally invasive methods.

If both right and left lungs meet the meet the requirements of Table 4, then the process proceeds to the decision box 730, where the Heterogeneity Score (HS) for the lungs are examined. In this operation, the lung with the highest HS is targeted for minimally invasive treatment. Thus, if the right lung has the highest HS, then the method proceeds to flow diagram box 720, where the right upper lobe (RUL) or right lower lobe (RLL) is targeted, whichever has the higher Emphysema Score. On the other hand, if the left lung highest HS, then the method proceeds to flow diagram box 725, where the left upper lobe (LUL) or left lower lobe (LLL) is targeted, whichever has the higher Emphysema Score.

With reference still to FIG. 7, if it is determined in the operation of decision box 730 that the HS is the same for both lungs, then the process proceeds to the decision box 735, where the Destruction Scores (DS) for the left and right lungs are examined. Specifically, the lung with the highest DS is targeted for minimally invasive treatment. Thus, the right lung and appropriate lobe are targeted pursuant to the flow diagram box 720 if the right lung has the highest DS. If the left lung has the highest DS, then the left lung and appropriate lobe are targeted pursuant to the flow diagram box 725. If the DS is equivalent in both lungs, then the right lung and appropriate lobe are targeted pursuant to the flow diagram box 720. In the foregoing example, the right middle lobe is not treated, and the lingual is considered part of the left upper lobe.

Clinical results to date suggest that some patients experience the most benefit when the target lobe is completely isolated, meaning that all airways feeding air to the target lobe are implanted with one or more one-way valve bronchial isolation devices or other bronchial isolation devices. It has been theorized that the reason for this is due to the high probability of damage to intralobar segmental boundaries in cases of advanced emphysema, which leads to open collateral air pathways from segment to segment. If an entire lobe is not completely isolated using bronchial isolation devices or valves, gas may freely travel from a non-valved segment to a valved segment through collateral pathways created by the destruction from emphysema, and thus reducing the potential benefit. Consequently although positive clinical results have been achieved in cases where not all segments of a lobe have been isolated, an exemplary targeting strategy involves complete isolation of all airways leading to the target lobe (referred to as lobar exclusion). There may be certain clinical conditions in which non-lobar exclusion is the preferred method, such as in the case of high-risk patients with DLCO<15% predicted value or others not mentioned.

Once it is determined which zone of the lung is targeted for isolation, then minimally invasive methods are employed with respect to the targeted zone. For example, one or more bronchial isolation devices are positioned in the lung to achieve the isolation. The bronchial isolation devices can be placed at the lobar, segmental, or sub segmental levels of the bronchial passageway that leads to the target lobe in this order of preference, depending on the anatomy of the patient. Whenever possible, bronchial isolation devices are placed in an earlier generation bronchus. For example, if a large bronchial isolation device will fit in the left upper lobe bronchus, that bronchus should be the target for placement of the device, rather than placing the devices in each of the segmental bronchi that branch from the left upper lobe bronchus.

Table 7 identifies the segmental bronchi that are implanted with bronchial isolation devices for isolation of the various lung lobes.

TABLE 7
Segmental Bronchial Targets for Lobar Exclusion

| | Bronchial | |
|---|---|---|
| | Segment | |
| | Number | Bronchi |
| Right Upper | B1 | Apical |
| Lobe | B2 | posterior |
| | B3 | anterior |
| Right Lower | B6 | superior, lower lobe |
| Lobe | B7 | medial basal |
| | B8 | anterior basal |
| | B9 | lateral basal |
| | B10 | posterior basal |
| Left Upper Lobe | B1 + 2 | apicoposterior |
| | B3 | anterior |
| | B4 | superior lingular |
| | B5 | inferior lingular |
| Left Lower Lobe | B6 | superior, lower lobe |
| | B7 + 8 | anteromedial basal |
| | B9 | lateral basal |
| | B10 | posterior basal |

Typically, treatment would take place in the course of a single clinical procedure. However treatment may also take place over a series of staged procedures.

Treatment Targeting Example #2: Heterogeneous Disease with Lobar Analysis

As with the previous treatment targeting method using zonal analysis, treatment targeting with lobar analysis is also based on the previously-obtained scores, such as the CT or HRCT Emphysema Scores and the calculated Heterogeneity Score (HS) and Destruction Score (DS). Where lobar analysis is used, the formulas for calculating HS and DS vary from the formulas used in zonal analysis. The formulas for calculating HS and DS are shown below in Table 8 with respect to lobar analysis.

TABLE 8
Lobar Heterogeneity Score and Destruction Score

| | Right Lung | Left Lung |
|---|---|---|
| HRCT Grading | Upper Lobe | Upper Lobe |
| | Emphysema Score = a | Emphysema Score = c |
| | Lower Lobe | Lower Lobe |
| | Emphysema Score = b | Emphysema Score = d |
| Heterogeneity | \|a − b\| = Right HS | \|c − d\| = Left HS |
| Score (HS) | | |
| Destruction | a + b = Right DS | c + d = Left DS |
| Score (DS) | | |

As in the zonal analysis example above, only one lobe of one lung is treated using minimally invasive methods. The flow chart of FIG. 7 (described above) also described the process of determining which lung and which lobe to treat pursuant to lobar analysis. In lobar analysis, the Emphysema Scores are first examined, as shown in the flow diagram box 715 of FIG. 7. The lung that has Emphysema Scores (ES) that correspond to an unshaded box in Table 5 is targeted. If both lungs meet the requirements of Table 5, then the lung with the highest Heterogeneity Score (HS) is targeted, as represented by the flow diagram box 730. If both lungs have the same HS, then the lung with the highest DS is targeted for minimally invasive treatment, as represented by the flow diagram box 735. Finally, if both lungs have the same DS, then the right lung is targeted. Once the target lung for treatment is determined, the lobe for treatment is then determined. In all cases, once the appropriate side of the lung has been determined, the upper or lower lobe of that lung with the highest ES is identified as the target lobe for treatment. In this treatment method, the lingula is considered part of the upper left lobe and the middle lobe of the right lung is not targeted in this method.

As with the previous treatment targeting example using zonal analysis, the clinical results to date using lobar analysis also suggests that patients experience the most benefit when the target lobe is completely isolated with minimally invasive treatment. Consequently, although positive clinical results have been achieved in cases where not all segments of a lobe have been isolated, an exemplary embodiment utilizes complete isolation of all airways leading to the target lobe; hereafter referred to as lobar exclusion. There may be other clinical situations in which non-lobar exclusion is the preferred strategy.

As with in the previous example, bronchial isolation devices may be placed at the lobar, segmental, or sub segmental levels in this order of preference, depending on the anatomy of the patient. Whenever possible, bronchial isolation devices are placed in an earlier generation bronchus, e.g.: if a large bronchial isolation devices will fit in the left upper lobe bronchus, that should be the target instead of bronchial isolation devices placed in each of the segmental bronchi. Bronchial targets for bronchial isolation device implantation at the segmental bronchi level for lobar exclusion are shown in Table 7. It should be appreciated that these lobes may also be isolated with a single device implanted in the lobar bronchi, or with a greater number of devices implanted in the sub-segmental bronchi.

As described above, typically, treatment takes place in the course of a single clinical procedure, however, at the discretion of the treating physician, treatment may also take place over a series of staged procedures.

Treatment Results

In the examples of bronchial isolation presented previously, treatment was performed by implanting one-way valve bronchial isolation devices into the target bronchial lumens as determined by the targeting methodology for heterogeneous emphysema. There are at least two distinct goals of these treatment strategies for treating patients with heterogeneous emphysema: (1) Reduction in hyperinflation as measured by residual volume (RV); and (2) Improvement of flow dynamics.

1. Reduction in Residual Volume (RV)

With this treatment strategy, the mechanism of improvement is very similar to that of lung volume reduction surgery (LVRS). The highly diseased, most compliant portion of the lung is isolated resulting in a net improvement (i.e., reduced compliance) in the patient's compliance curve, which leads to reduced RV. This allows the healthier portion of the lung (that had been compressed by the hyperinflated diseased lung) to re-expand and fill the volume previously occupied by the hyperinflated, diseased lung. This, in turn, allows the diaphragm to attain a more normal and anatomically favorable shape, and the healthier portion of the lung can expand to greater lung volumes, leading to better oxygenation and more efficient gas transfer. In patients with advanced heterogeneous emphysema, it is very common for the destruction due to emphysema to open up collateral air channels between adjacent segments. Due to this, it is highly likely that there is extensive segment-to-segment collateralization within a lobe, thus it is necessary to perform bronchial isolation on all bronchial lumen feeding the treated lobe in order to achieve maximum volume reduction. If the disease is less severe, or the disease is homogeneously distributed, bronchial isolation may be performed on a portion of the lung that is smaller than a lobe, such as a lung segment, in order to achieve volume reduction.

2. Improvement of Flow Dynamics

With this treatment strategy, the goal is to improve lung flow dynamics and pulmonary function without necessarily producing a net reduction in the volume of the lung. Rather than reducing the size of the isolated lung portion, the goal is to implant bronchial isolation devices in order to prevent inhaled air from flowing into the isolated lung through the normal airways. This results in inhaled air being preferentially guided to the healthier, non-isolated lung regions. The effect is that the non-isolated lung regions are better ventilated, and the hyper-inflation of the isolated lung regions is reduced. If one-way valve bronchial isolation devices are used, they allow mucus and air to flow out of the targeted lung region in the exhalation direction, and do not allow either to flow back in during inhalation. In order to achieve this benefit without attempting to collapse the isolated lung portion, there must be sufficient collateral flow into the isolated lung portion to prevent collapse. In patients with advanced emphysema, as stated earlier, there is likely to be extensive collateralization between segments of a lobe. In order to improve flow dynamics without attempting to induce volume changes, minimally invasive bronchial isolation would be performed on some, but not all, of the bronchial lumens feeding the target lobe (if all bronchial lumens feeding the target lobe are treated, volume changes will likely occur). Alternately, if there is sufficient collateral flow into the lobe such that the lobe will not collapse even when it is completely isolated, minimally invasive lung isolation may be performed on all bronchial lumens feeding the lobe in order to improve flow dynamics without collapse.

Although the patient selection and treatment method examples presented earlier focused on the application of this technology as a treatment for patients suffering from heterogeneous emphysema, there are numerous other possible treatment strategies for patients with heterogeneous emphysema. In addition, there are many other patient subgroups and treatment methods possible. For example, patients with a homogeneous distribution of disease could be treated, patients with less severe disease than those used in the examples could be treated and in another embodiment, bullous emphysema could be treated. Surgical resection of diseased lung tissue in patients with giant bullous disease is a well established and accepted technique. Minimally invasive lung isolation could be preformed to treat the giant bullae by isolating (for example by implanting bronchial isolation devices) all of the bronchial lumens leading to the giant bullae. In addition, the patient selection and treatment methods presented earlier can be applied to pulmonary diseases other than emphysema such as chronic bronchitis, air leaks, and obliterative bronchiolitis to name just a few.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

1. A method of determining a treatment strategy for minimally invasive lung treatment, comprising:
performing at least one diagnostic procedure on a patient to obtain at least one diagnostic result; and
determining that the patient is eligible for minimally invasive lung treatment if at least one diagnostic result satisfies predetermined eligibility criteria.

2. The method of claim 1, wherein the at least one diagnostic procedure comprises a spirometric test and wherein the at least one diagnostic result includes at least one of the group consisting of forced expiratory volume in one second (FEV₁), forced vital capacity (FVC), and forced expiratory flow, 25% to 75% (FEF_{25%-75%} ).

3. The method of claim 1, wherein the at least one diagnostic procedure comprises a spirometric test and wherein the at least one diagnostic result includes a combination of two or more of the group consisting of forced expiratory volume in one second (FEV₁), forced vital capacity (FVC), and forced expiratory flow, 25% to 75% (FEF_{25%-75%} ).

4. The method of claim 2, wherein the eligibility criteria comprises FVC and wherein the patient is eligible for minimally invasive lung treatment if the patient's FVC is less than 80 percent of FVC predicted.

5. The method of claim 2, wherein the eligibility criteria comprises FVC and wherein the patient is eligible for minimally invasive lung treatment if the patient's FVC is less than 70 percent of FVC predicted.

6. The method of claim 2, wherein the eligibility criteria comprises FVC and wherein the patient is eligible for minimally invasive lung treatment if the patient's FVC is less than 60 percent of FVC predicted.

7. The method of claim 2, wherein the eligibility criteria comprises FVC and wherein the patient is eligible if the patient's FVC is less than 50 percent of FVC predicted.

8. The method of claim 2, wherein the eligibility criteria comprises FVC and wherein the patient is eligible if the patient's FVC is less than 40 percent of FVC predicted.

9. The method of claim 2, wherein the diagnostic procedure comprises at least one plethysmographic test.

10. The method of claim 1, wherein the diagnostic procedure comprises an imaging procedure.

11. The method of 10, wherein the imaging procedure comprises a computed tomography (CT) scan.

12. The method of claim 1, wherein the at least one diagnostic procedure yields multiple diagnostic results, and wherein the patient is eligible if a combination of the diagnostic results meet eligibility criteria.

13. The method of claim 1, further comprising identifying at least one lung region to be targeted for minimally-invasive lung treatment based on the diagnostic results.

14. The method of claim 1, further comprising performing a second diagnostic procedure to obtain second diagnostic results and identifying at least one lung region to be targeted for minimally-invasive lung treatment based on the second diagnostic results.

15. The method of claim 1, wherein the diagnostic procedure provides diagnostic results that indicate aggregate information regarding the lung function of both lungs.

16. The method of claim 1, wherein the diagnostic procedure provides diagnostic results that provide regional or localized information about the disease state of the patient's lungs.

17. A method as defined in claim 1, further comprising developing a treatment strategy and wherein the treatment strategy is to completely isolate a lung lobe using minimally invasive bronchial isolation device.

18. A method as defined in claim 1, further comprising developing a treatment strategy and wherein the treatment strategy is to intentionally refrain from placing a minimally invasive bronchial isolation device in at least one bronchial airway leading to the target lobe, while placing at least one minimally invasive bronchial isolation device in a bronchial airway leading to that target lobe.

19. A method of determining a treatment strategy for minimally invasive lung treatment of a patient, comprising:
performing at least one test on the patient to obtain data indicative of a lung disease;
developing a treatment plan based on the data, wherein the treatment plan specifically identifies at least one lung region to be targeted for minimally-invasive lung treatment.

20. A method as defined in claim 19, wherein the data provides information relating to localized lung characteristics.

21. A method as defined in claim 19, wherein the data provides information relating to global lung characteristics.

22. A method as defined in claim 19, wherein the at least one test comprises a computed tomography (CT) scan or a high-resolution computed tomography (HRCT) scan and wherein the data comprises at least one cross-sectional image of the patient's lung.

23. A method as defined in claim 19, wherein the at least one test is performed repeatedly during the time it takes for the patient to perform a breathing maneuver.

24. A method as defined in claim 19, further comprising analyzing the data to obtain at least one score indicative of the level of disease in at least one region of the patient's lung.

25. A method as defined in claim 24, wherein the at least one region comprises a lobe of the lung.

26. A method as defined in claim 24, wherein the score is obtained by a computer.

27. A method as defined in claim 24, wherein the treatment plan is developed based on a comparison of the scores obtained for the lung regions.

28. A method as defined in claim 19, wherein the minimally invasive treatment includes placing one or more bronchial isolation devices in the lung to completely isolate a targeted lung region.

29. A method as defined in claim 19, wherein a plurality of bronchial passageways provide air to the targeted lung region, and wherein the treatment plan selectively identifies at least one of the bronchial passageways for placement of a bronchial isolation device.

30. A method as defined in claim 19, wherein the treatment plan intentionally refrains from placing a bronchial isolation device in at least one of the bronchial passageways leading to the targeted lung region.

31. A method of planning lung treatment, comprising:
detecting the presence, degree, and distribution of a disease in the lung;
analyzing results of the detecting step to obtain at least one grade indicative of the level of disease in at least one region of the lung; and
identifying a lung or a region of the lung to be treated based on at least one grade obtained in the analyzing step.

32. A method as defined in claim 31, additionally comprising determining whether a patient is suitable for treatment based on the grades obtained in the analyzing step.

33. A method as defined in claim 31, wherein detecting the presence, degree, and distribution of a disease in the lung comprises determining a region of the lung that is diseased.

34. A method as defined in claim 31, wherein a computed tomography (CT) scan is used to detect the presence, degree, and distribution of the disease in the lung.

35. A method as defined in claim 31, wherein a high-resolution computed tomography (HRCT) scan is used to detect the presence, degree, and distribution of the disease in the lung.

36. A method as defined in claim 31, wherein the at least one grade obtained in the analyzing step includes emphysema score, heterogeneity score, and destruction score.
